(19) United States
(12) Patent Application Publication
(10) Pub. No.: US 2005/0094732 A1
(43) Pub. Date: May 5, 2005

(54) Data communications methods, compressed media data decoding methods, compressed media data decoders, articles of manufacture, and data communications systems

(76) Inventor: Debargha Mukherjee, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/698,885

(22) Filed: Oct. 30, 2003

(51) Int. Cl. H04N 7/12

(52) U.S. Cl. 375/240.25; 375/240.12

(57) ABSTRACT

Data communications methods, compressed media data decoding methods, compressed media data decoders, articles of manufacture, and data communications systems are described. According to one aspect, data communications method includes providing configuration parameters regarding capabilities associated with a receiving device and usable to implement scaling of media data to be received, receiving media data scaled according to the configuration parameters and comprising a plurality of frames for generating a plurality of respective images, initially decoding compressed media data for an initial one of the frames and less than all of the frames, initially displaying at least one visual image using the initially decoded media data, randomly selecting an other of the frames after the displaying, subsequently decoding compressed media data of the other of the frames after the initially decoding and the initially displaying, and subsequently displaying an other visual image using the subsequently decoded media data.

### FIELD OF THE INVENTION

Aspects of the invention relate to data communications methods, compressed media data decoding methods, compressed media data decoders, articles of manufacture, and data communications systems.

### BACKGROUND OF THE INVENTION

Interactive media sessions are increasing in popularity. As the processing power of computers continues to increase, and communications bandwidth of communications devices is improved, the popularity of interactive media communications is also expected to increase. However, to date, the substantial focus has been on media delivery with relatively little advancements for interactive media experiences.

Some arrangements of video coding use a plurality of images of a sequence. In some implementations, the images of the sequence are decoded linearly in time. However, for interactive viewing, a user may randomly request specific images out of linear order as the user navigates an image. Exemplary interactive media communications sessions may involve 3D graphics or other rich interactive media having very large files (even after compression) to be communicated and processed. The amount of data increases exponentially with richness and raises formidable issues in distribution and experience of the media over the Internet.

In many situations, it may not be possible to communicate the associated files to clients in entirety before experience commences. In fact, even very high bandwidth connections by modern standards may not be able to accommodate these interactive media files. This problem is compounded by the presence of clients connecting to a source of the interactive media files having diverse capabilities. For example, at least some of the clients may be coupled with relatively slow communications connections, use computers of relatively slow processing capabilities, or use computers with limited display capabilities.

One method of implementing communications of very large interactive media files has been to maintain multiple versions of the same media, and to serve one to each client based upon the user's capabilities. This method has significant drawbacks with respect to handling and maintenance of files if all possible combinations of different types of scalability are supported inasmuch as numerous versions of the media are used.

In addition, providing random access of frames and images during user navigation responsive to user inputs also presents complications. Some compression schemes of video sequences are not readily adaptable to enable random access. For example, exemplary image based 3D viewing products may use independent image coding with JPEG to provide random accessibility. However, independent coding of all images in a sequence is inefficient in terms of coding.

H.263 family coding may use an efficient IPPPPP prediction structure for an entire sequence. This approach is considered efficient in terms of compression but does not support random accessibility without decoding a bit-stream in entirety before viewing starts. This has the associated drawbacks of leading to delay in start-up and immense run-time memory requirements in the viewer.

Use of a MPEG-like repetitive prediction structure IBBPBBPBBPBBPBBI has associated drawbacks regarding indexing of I-frames. Even if indexes to I-frames are provided (which are pre-decoded and stored in order to randomly decode a frame), a maximum of 5 frames may need to be decoded. This decoding may be too extensive to support immersive real-time viewing.

At least some aspects of the disclosure provide improved methods and apparatus for communicating media data for a plurality of images.

### SUMMARY OF THE INVENTION

Aspects of the invention relate to data communications methods, compressed media data decoding methods, compressed media data decoders, articles of manufacture, and data communications systems.

According to one aspect, a data communications method comprises providing configuration parameters regarding capabilities associated with a receiving device and usable to implement scaling of media data to be received, receiving media data scaled according to the configuration parameters and comprising a plurality of frames for generating a plurality of respective images, initially decoding compressed media data for an initial one of the frames and less than all of the frames, initially displaying at least one visual image using the initially decoded media data, randomly selecting an other of the frames after the displaying, subsequently decoding compressed media data of the other of the frames after the initially decoding and the initially displaying, and subsequently displaying an other visual image using the subsequently decoded media data

According to another aspect of the invention, a compressed media data decoder comprises an interface configured to access compressed media data comprising a plurality of frames usable to generate a plurality of respective images, wherein the frames comprise a plurality of frame types, and processing circuitry coupled with the interface and configured to initially decode a first type of the frames at an initial moment in time to initiate viewing of at least one of the images, to control a display to depict the at least one image, to access a data request for depiction of another one of the images after the depiction of the at least one image, and to decode the compressed media data of another frame comprising a second type of frame using the initially decoded media data of the frame corresponding to the at least one image.

Other aspects of the disclosure are disclosed herein as is apparent from the following description and figures.

### DESCRIPTION OF THE DRAWINGS

FIG. 1 is an illustrative representation of an exemplary communications system arranged according to one embodiment.

FIG. 2 is a block diagram of exemplary transmitting and receiving communications devices according to one embodiment.

FIG. 3 is an illustrative representation of an exemplary general prediction structure according to one embodiment.

FIG. 4 is an illustrative representation of an exemplary organization of a bit stream according to one embodiment.

FIG. 5 is an illustrative representation of an exemplary general prediction structure using intra coded anchor frames according to one embodiment.

FIG. 6 is an illustrative representation of an exemplary general prediction structure using intra coded and predictively coded anchor frames according to one embodiment.

FIG. 7 is an illustrative representation of an exemplary general prediction structure according to one embodiment.

FIG. 8 is an illustrative representation of exemplary wavelet decomposition according to one embodiment.

FIG. 9 is an illustrative representation of exemplary spatial scalability layers according to one embodiment.

FIG. 10 is an illustrative representation of exemplary nested temporal and spatial scalability layers according to one embodiment.

FIG. 11 is an illustrative representation of exemplary nested temporal, spatial and SNR scalability layers according to one embodiment.

FIG. 12 is an illustrative representation of an exemplary general prediction structure for multiple synchronous sequences according to one embodiment.

FIG. 13 is an illustrative representation of another exemplary general prediction structure for multiple synchronous sequences according to one embodiment.

FIG. 14 is an illustrative representation of an exemplary four level nested scalability structure for multiple synchronous sequences according to one embodiment.

### DETAILED DESCRIPTION OF THE INVENTION

At least some aspects of the disclosure are directed towards a method for scalable compression and representation of a sequence of images to obtain a scalable bit-stream, as well as a complementary method for scalable decompression with random access and interactive viewing of the sequence from the compressed bit-stream. As described below, at least some aspects are directed towards communication of a one-dimensional sequence of images or accommodation of multiple synchronous sequences.

Exemplary compression and scaling of communications may be applied to a sequence of images. A one-dimensional image sequence may be obtained by one of several capture methods. For example, the image sequence may be captured using a stationary camera shooting pictures of an object being rotated on a turntable, a camera placed on a rotating arm looking inwards at the center of rotation where a stationary object is placed, a camera rotating at the center on a turntable looking outwards at the surrounding scene, or a hand-held or tripod mounted progressive scan camera used to pan a scene. Other capture methods may be used.

In one embodiment, following capture of an image sequence, the sequence may be compressed in a manner so that a decoder can randomly decode any image from the compressed bit-stream without undergoing significant computations to uncompress the media data and process the media data if scaled as described herein. At least one aspect of this functionality enables interactive immersive viewing applications where a user may obtain different views of an object or scene being viewed or navigated.

Random access of images and respective frames from an image sequence may be achieved by encoding individual images independently and adding a Table of Contents (TOC) at the beginning of the bit-stream so that a decoder/viewer may determine where to start decoding a requested frame. The above-described method may preserve random accessibility, as well as provide increased amounts of compression compared with independent coding of images.

At least some aspects of the disclosure use compression schemes to provide improved coding efficiency using inter-frame prediction while still preserving random access capability of independent image coding to a significant degree. Additional aspects provide a scalable compression scheme so that different resolutions (temporal or spatial) are obtained from different subsets of a common bit stream enabling distribution over a heterogeneous Internet or other network.

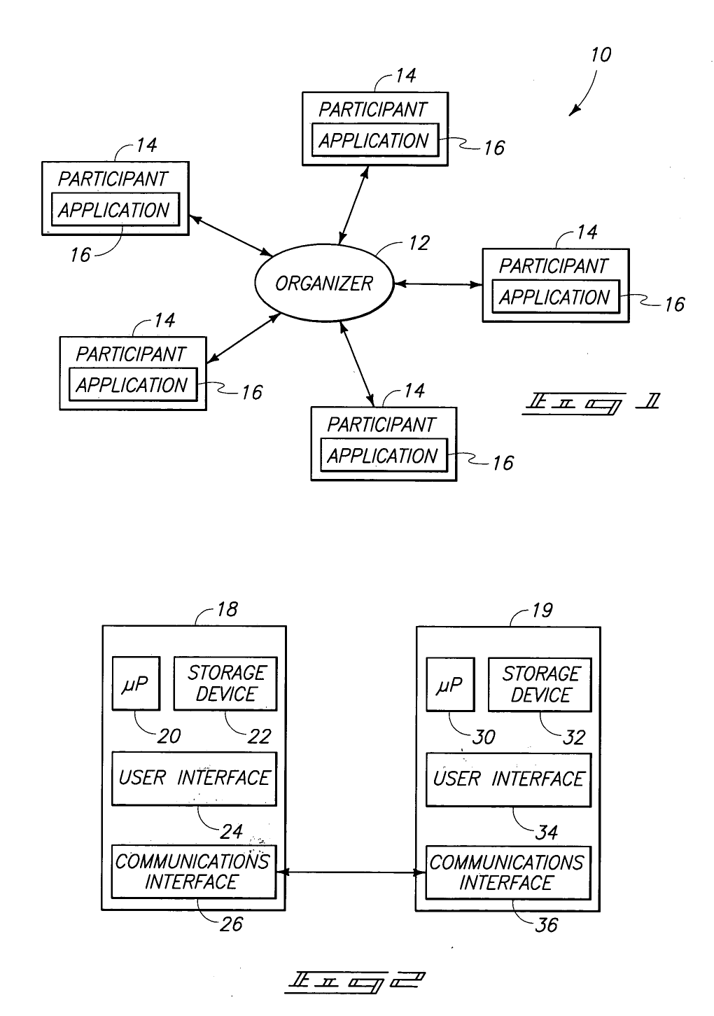

Referring to FIG. 1, an exemplary collaboration session implemented using a communications system 10 is shown. Communications system 10 is one exemplary embodiment configured to facilitate collaboration amongst a plurality of recipient devices (e.g., participants 14 described below). The discussions with respect to FIG. 1 may also be applied to any transmission of compressed scalable media data intermediate a transmitting or sending device (e.g., organizer 12 of FIG. 1) and a receiving device (e.g., one or more participant 14). For example, as shown in FIG. 2, at least some aspects of the disclosure presented with respect to the configuration of FIG. 1 are equally applicable to the configuration of FIG. 2 or any other arrangement involving communications between a transmitting device and a receiving device.

In one embodiment, communications in system 10 may be compressed and provide randomly accessible images within an image sequence. Further, the communications may be scalable for communication of media data to heterogeneous users. The exemplary communications system 10 provides data communications between a plurality of participants or users. In a more specific exemplary embodiment, communications system 10 may implement a multipoint meeting where two or more individual participants communicate by exchange of any information, data, or media concurrently in order to achieve a specific goal. Communications system 10 may support multimedia collaboration between a plurality of individuals or entities. The depicted communications system 10 is exemplary. In other embodiments, communications system 10 may comprise a single sending device and a single receiving device, or any other desired arrangement for implementing transmitting and receiving operations of the media data as mentioned above.

The illustrated communications system 10 comprises a collaboration infrastructure comprising a session organizer 12 configured to implement communications within the communications system 10. Organizer 12 may comprise a single server or a plurality of servers (e.g., arranged in a peer-to-peer arrangement) in possible embodiments.

A plurality of participants 14 are coupled with organizer 12 in the illustrated embodiment. Exemplary participants 14 comprise computing devices and may be embodied as personal computers, visualization workstations, personal digital assistants (PDAs), or other devices capable of receiving compressed interactive media data, decoding the interactive media data, communicating the interactive media data to a user, processing interactive user commands, and formulating data requests. During communications, participants 14 connect to organizer 12 using the communications system to form an interactive media session. In one embodiment, the communications system 10 of the collaboration infrastructure may comprise network connections (e.g., Internet) providing coupling of the participants 14 with organizer 12, and hardware and appropriate programming of organizer 12 and participants 14. At a given moment in time, organizer 12 may be arranged to implement a plurality of different interactive media sessions between respective different groups of participants 14 in at least one embodiment.

In one arrangement, participants 14 individually execute an application 16 to participate in an interactive media session. Applications 16 may implement communications modules to establish communications (e.g., start or join a session) and provide transcoding or decoding operations of received data. In one embodiment, applications 16 provide standardized protocols for communications between organizer 12 and participants 14 allowing sessions 10 to be created, participated in, and terminated by users as well as provide interactive exchange of media in a seamlessly scalable manner. Applications 16 may provide interaction in different ways with different types of media including organizing, transcoding and viewing specific types of content as well as processing user inputs and formulating data requests. Accordingly, the communications modules of applications 16 provide connections to organizer 12 so sessions 10 may be initiated, joined, or terminated by participants 14 as well as interacting with content in one embodiment.

Organizer 12 is configured to implement a heterogeneous interactive media session 10 in one aspect wherein organizer 12 communicates with participants 14 having different communications, processing, display or other terminal capabilities. For example, different communications attributes may correspond to the specific implementations or configurations of the present participants 14 which may vary widely in a given interactive media session 10. In a given session 10, participants 14 may have different capabilities corresponding to one or more of the respective network connections providing different rates of data transfer for the participants 14, different processing circuitry (e.g., microprocessor executing respective software or other programming) of participants 14 providing different processing powers, different resolutions of displays of participants 14, etc. Organizer 12 is configured to implement interactive media session 10 providing communication of scalable media data with respect to the heterogeneous participants 14 wherein the participants 14 with limited abilities do not adversely impact communications with respect to participants 14 having greater abilities in one embodiment.

Accordingly, at least some aspects of the disclosure provide scaling of media data by organizer 12 and communication of the scaled data to participants 14 within a given interactive media session 10 to provide heterogeneous communications enabling communications to participants 14 having different capabilities. Scalable encoding formats and meta-formats are described in “Proposals for End-To-End Digital Item Adaptation Using Structured Scalable Meta-Formats (SSM),” listing Debargha Mukherjee, Geraldine Kuo, Amir Said, Girodano Beretta, Sam Liu, and Shih-ta Hsiang as authors, (published October, 2002), and a co-pending U.S. patent application entitled “System, Method and Format Thereof For Scalable Encoded Media Delivery,” listing Debargha Mukherjee and Amir Said as inventors, having U.S. patent application Ser. No. 10/196,506, filed Jul. 15, 2002, having client docket no. 100202339-1, and the teachings of which are incorporated herein by reference.

In one scaling implementation, participants 14 may communicate a respective client profile to organizer 12 prior to communications in an interactive media session 10 (e.g., upon session creation or a participant 14 joining a session 10) or at another moment in time. The client profile may define one or more configuration parameter for the respective communicating participant 14 defining one or more maximums for one or more individual levels of scalability (e.g., signal-to-noise ratio (SNR), resolution, temporal and interactivity) that the respective device 14 can receive and process. In another embodiment, organizer 12 senses the configuration parameters of respective recipient participants 14. Exemplary configuration parameters comprise receiving attributes corresponding to the capabilities of the respective participant 14 to receive, process or display the media data. Exemplary receiving attributes may be defined by or include unique parameters of one or more of communications bandwidth, processing speeds, or display resolution with respect to the participant 14. Exemplary receiving attributes may also be referred to as outbound constraints and include limit constraints (i.e., limiting values for attribute measures) and optimization constraints (e.g., requested minimization or maximization of attribute measures) as discussed in the U.S. patent application Ser. No. 10/196,506.

Client profiles may convey terms of meaningful defined levels such as signal-to-noise ratio (SNR), resolution, temporal and interactivity to implement scaling operations. Additional levels may be defined and used in other embodiments. The client profiles may convey specifications for these or other qualities in a top-down order by means of a 4-tuple in one embodiment (e.g., a resolution client profile of 1 conveys that the respective participant 14 is able to receive the highest resolution, a resolution client profile of 2 coveys abilities to receive the second highest resolution and so on).

Organizer 12 is arranged to access the client profiles for the respective participants 14 and to scale media data to be communicated to the respective participants 14 in accordance with receiving attributes of the participants 14 providing a plurality of respective scaled data streams comprising different amounts of media data regarding a subject or object of an image for communication to participants 14. Details regarding exemplary implementation of scaling of randomly-accessible compressed media data using temporal, spatial signal-to-noise ratio, and interactivity scaling attributes are described below.

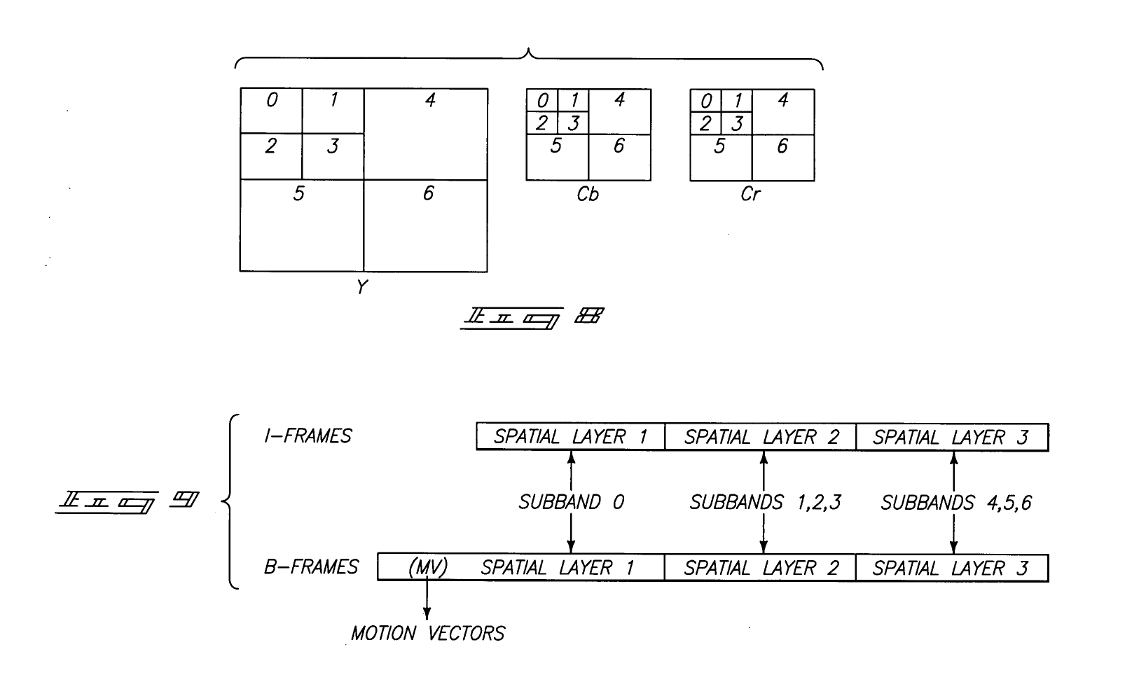

In one embodiment, the configuration parameters comprising receiving attributes of the recipient participants 14 and the scalability attributes of the media data are used to implement scaling. For example, the organizer 12 may access the respective receiving attributes for one or more appropriate recipient participants 14 to receive the data, match the scalability attributes and the respective receiving attributes, and scale the media data using the matched attributes to truncate, rearrange or otherwise modify the media data to provide the respective data stream(s) for communication. Further scaling details are also described in the U.S. patent application having Ser. No. 10/196,506 wherein subsets of media data may be truncated, rearranged or otherwise modified to implement scaling. In one example described below in FIG. 7, scaling may be implemented by truncating media data in at least some of the temporal layers to provide images of reduced temporal resolution to correspond with configuration parameters of the receiving device. Other scaling embodiments are possible.

Media data may comprise interactive media data usable by participants 14 to display an image and offer interaction of the user with respect to the image. In one embodiment, the organizer 12 sends an entirety of media data regarding a sequence of images to one or more participants 14 to enable user interaction with respect to the images. Individual ones of participants 14 may thereafter process data requests generated by user interaction and display new images using additional media data. In another embodiment, the organizer 12 sends an initial amount of media data to one or more participants 14 and thereafter forwards additional media data to participants 14 during user interaction (e.g., “on-the-fly”) to provide media data for additional images.

In one embodiment, an entirety of the sequence of images is represented using one or more bi-directionally predicted frames (B-frames), Intra coded frames (I-frames) and predicatively coded frames (P-frames). An entirety of the frames may be communicated from organizer 12 to one or more participant 14 as mentioned above. Alternately, the I-frames and P-frames may be referred to as anchor frames and be communicated as initial media data to one or more participant 14, and thereafter, the B-frames may be communicated “on-the-fly” during user interaction responsive to data requests.

Users may interact with displayed images by generating user inputs. For example, the user may request different views of a subject of the image during navigation. In one implementation, the initial image may comprise a 3D interactive image of a subject (e.g., house). An index of the 3D image may be defined in any convenient or desired format for retrieving subsequent interactive media data. In one example, viewing angles about the subject may correspond to respective addressing values of the index. In another example, addressing values may be represented as vectors, perhaps corresponding to coordinates of a multi-dimensional grid of the 3D image. In another possible embodiment, addressing values of the index may correspond to details of subject, such as internal components of the 3D image (e.g., rooms of the house). Any suitable indexing scheme or space may be used to provide additional interactive media data to users as needed. The additional interactive media data may include data regarding additional details of information present in the initial interactive media data or data regarding details not present in the initial interactive media data in at least some embodiments. The indexing may be implemented using a table of contents of the bit stream of media data as described below.

Accordingly, users may request different portions of the media data depending upon their respective navigations of the initial or other portions of the media data. Requests may be embodied as data requests configured to access additional indexed frames, for example using the table of contents. In an embodiment wherein an entirety of the media data is communicated to participants 14, the individual participants 14 may formulate respective data requests from user inputs. The internal data requests may be used to obtain additional information using addressing values of the table of contents to identify desired frames, extract the frames, process the frames (e.g., B-frames) and produce images of the frames as requested based upon the user navigation.

In an embodiment wherein only a portion of the media data is communicated to participants 14 at an initial moment in time, the respective participants 14 may be configured to translate the user inputs of the interactions into respective addressing values of the index and to pass the addressing values to organizer 12. Organizer 12 may extract the requested frames (e.g., B-frames) using the addressing values and the table of contents, scale the data if appropriate, and forward the extracted media data to respective participants 14 in real time during the user navigation. Individual participants 14 may decode the newly received media data and present the newly formed images to the users.

In one embodiment, the participants 14 may initially decode media data for less than an entirety of the frames at an initial moment in time. For example, the anchor frames of the media data may be initially decoded upon receipt regardless of whether the media data is sent in its entirety from organizer 12 to participants 14, or only the initial media data is communicated. In one embodiment, an entirety of the anchor frames may be initially decoded automatically upon receipt and without user input or without requests for additional data. The decoded anchor frame media data may be internally stored within the participant 14. An initial one of the anchor frames may be used to formulate an initial visual image to initiate the viewing experience for a user. The initial visual image may be depicted prior to decoding of an entirety of the compressed media data (e.g., frames other than anchor frames, such as B frames).

User interactions with respect to the displayed images may result in requests additional images. The requests may randomly request respective images responsive to user inputs during navigation. For example, although the images may be arranged in sequence, the user navigation or interaction may request a frame which is not in linear sequential order but removed by one or more frame from a currently displayed image of a frame (i.e., the request may be for a frame out of sequence). Data requests may be processed to identify or select the requested frames (e.g., using a table of contents). Thereafter, the identified frames may be decoded and used to display the respective images in real time during user interaction.

If an additional requested image is for an anchor frame, the participant 14 may readily display the requested image using the already decoded media data of the anchor frame in one embodiment. If an additional requested image corresponds to a B-frame, the participant 14 may use the already decoded media data of the anchor frames to decode the media data of the requested B-frame. The decoded media data of the B-frame may be used to generate a requested image. Accordingly, in one embodiment, and during interaction of the user following the initial decoding of the anchor frames, media data for no more than a single B-frame is decoded to display an image of the B-frame.

According to one exemplary embodiment, the anchor frames may be referred to as a first type of frames and the B-frames may be referred to as a second type of frames. The first type of frames may be initially decoded upon communication to the participant 14 and the second type of frames may be decoded “on-the-fly” during user interaction. The decoded data of the first type of frames comprising anchor frames may be used to decode the media data of the second type of frames comprising B-frames in one embodiment. Additional details regarding processing of media data, scaling, and compression are described below.

Referring to FIG. 2, exemplary communications between a sending or transmitting device 18 and a recipient or receiving device 19 are described. Transmitting device 18 is configured to communicate scaled compressed media data to receiving device 19 in the described arrangement. In one embodiment, the designation of transmitting device 18 and receiving device 19 is with respect to the flow of media data from a sending device to a destination. As mentioned below, bi-directional communications between devices 18, 19 may also be provided (e.g., transmission of data requests from receiving device 19 to transmitting device 18). In one embodiment, the transmitting device 18 corresponds to organizer 12 and receiving device 19 corresponds to one of participants 14. Other embodiments or implementations of transmitting device 18 and receiving device 19 are possible.

In the illustrated embodiment of FIG. 2, transmitting device 18 comprises processing circuitry 20, storage circuitry or device 22, a user interface 24, and a communications interface 26, and the receiving device 19 includes processing circuitry 30, storage circuitry or device 32, a user interface 34, and a communications interface 36. Other embodiments of devices 18, 19 are possible.

In one embodiment, processing circuitry 20, 30 may comprise circuitry configured to implement desired programming. For example, the processing circuitry may be implemented as a processor or other structure configured to execute executable instructions including, for example, software and/or firmware instructions. Other exemplary embodiments of processing circuitry 20, 30 include hardware logic, PGA, FPGA, ASIC, and/or other structures. These examples of processing circuitry are for illustration and other configurations are possible. Processing circuitry 20, 30 may access programming, encode or decode compressed interactive media data, communicate interactive media data to a respective user, receive and process user inputs providing interaction, implement indexing operations with respect to interactive media data, formulate or process data requests, control the depiction of images for communication with respect to the user, and perform other desired operations. Accordingly, respective processing circuits 20, 30 configured to respectively encode media data and decode media data to implement compression or scaling operations in one embodiment may be referred to as an encoder and decoder, respectively.

Storage circuitry or device 22, 32 may be configured to store electronic data and/or programming such as executable instructions (e.g., software and/or firmware), data, or other digital information and may include processor-usable media. Processor-usable media includes any article of manufacture which can contain, store, or maintain programming, data and/or digital information for use by or in connection with an instruction execution system including processing circuitry in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

User interfaces 24, 34 are arranged to communicate information to a user and to receive user inputs during user interaction. User interfaces 24, 34 may comprise a display (e.g., cathode ray tube, liquid crystal display, or other arrangement) to depict visual media content and an input device (e.g., keyboard, mouse, or other arrangement) to receive user inputs. Other implementations are possible.

Communications interfaces 26, 36 are arranged to implement communications intermediate devices 18, 19. Communications interfaces 26, 36 may be embodied as a network interface card (NIC), modem, access point, or any other appropriate communications device. Interfaces 26, 36 are arranged to communicate scalable compressed media data, data requests and other desired information. Communications interfaces 26, 36 are arranged to implement bi-directional communications in at least one embodiment.

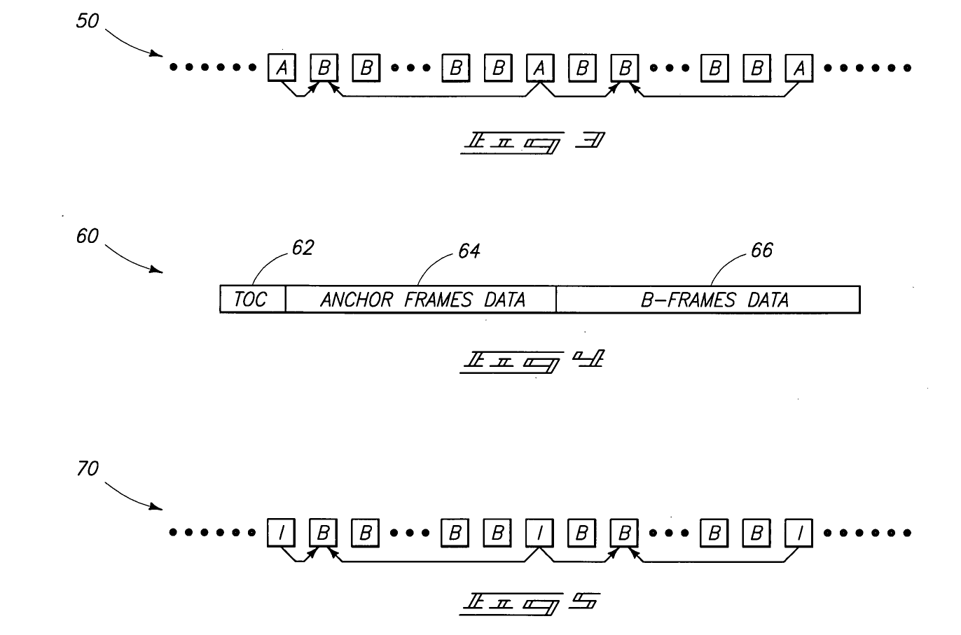

The discussion proceeds with respect to exemplary communications intermediate transmitting device 18 and receiving device 19. Random access compression of image sequences according to exemplary embodiments is described with respect to FIG. 3-FIG. 6.

At least some aspects of the disclosure provide a frame prediction structure where a large number of bi-directionally predicted frames (B-frames) are inserted between Intra coded frames (I frames) or predicatively coded (P frames). I-frames may be coded independently of other frames, P frames may be predictively coded using a single previous I- or P-frame as reference. B-frames may bi-directionally predicted using two reference I- or P-frames that come closest to the current frame in temporal order in one embodiment. B-frames are interesting for the current application because no other frames coded later depend on these frames, and they may be very efficient in terms of coding efficiency.

In one embodiment, I- or P-frames may be referred to as anchor frames as described above. The anchor frames may comprise initial media data if only a portion of media data is communicated from transmitting device 18 to receiving device 19. In an embodiment wherein all media data of a sequence is not initially communicated to receiving device 18, the B-frames may comprise subsequently communicated data which may be communicated “on-the-fly” during user interaction.

In one embodiment, anchor frames may be provided in every N frames (where N is typically 32, 16, 8, 4 or other convenient number) in an image sequence. In between frames are B-frames that are bi-directionally predicted from the two nearest anchor frames. In some sequences, the image sequence forms a closed circle (e.g., as a result of capturing images in a full circle around an object or scene). In this instance, the frames that come after the last anchor frame may be predicted from the last anchor frame and the first anchor frame of the sequence in one embodiment.

Referring to FIG. 3, an exemplary prediction structure 50 of an image sequence is shown wherein “A” refers to anchor frames and “B” refers to B-frames. The image sequence comprises a linear order of frames. An encoder of the transmitting device 18 may code every N frames independently using a DCT or wavelet based scheme (I-frames) in one embodiment. All other frames are coded bi-directionally from the nearest two I-frames in the exemplary structure. Individual B-frames may be motion compensated from the nearest anchor frames. Each macroblock in a B-frame may be either predicted from one or both of the two reference frames, or encoded in INTRA mode (i.e., coded independently with no prediction). If predicted, the residual error after prediction may be either DCT or wavelet encoded.

Referring to FIG. 4, an encoder of the transmitting device 18 may organize a bit stream 60 such that the media data corresponding to the anchor frames appears before the media data of the B-frames. The exemplary bit stream 60 may comprise a table of contents 62, anchor frames media data 64, and B-frames media data 66. TOC 62 may be used to point to byte positions where media data corresponding to a particular frame (both anchor and B-frames) begins. Anchor frames media data 64 may be referred to as initial data, for example, in embodiments wherein the entire bit stream is not initially communicated to the receiving device 19 as described above. B-frames media data 66 may be referred to as subsequent data, for example, in embodiments wherein the entire media data is not initially communicated to a receiving device 19. B-frames media data 66 may include motion vectors and residual error data.

When a decoder of receiving device 19 is used to view the image sequence, the decoder object initializes itself by decoding the anchor-frames part of the bit stream. In one embodiment described above, all the anchor frames are pre-decoded and stored inside the decoder object. The decoder also loads the data of TOC 62 from the bit-stream and communicates the first initial image of the first anchor frame to a user. As the user interacts with the media, additional frames are requested for display. The decoder object provides the requested frames when requested. If the required frame is an anchor frame, the decoder object simply produces it from the anchor frames pre-stored in it.

If a B-frame is requested and the B-frame data has not been communicated to receiving device 19, the receiving device 19 may forward a data request to transmitting device 18 for the media data of the respective, requested frame and decode the data upon receipt on the fly. If the B-frame data has been previously communicated to device 19, the decoder object may decode it on the fly based on the data it finds at the offset specified for the frame in the TOC 62.

B-frames 18 may be decoded in real time during user interaction using pre-stored anchor frame data 64. In particular, the decoder jumps to the offset specified for the requested frame, and decodes the motion vector data first. The motion vector data along with the pre-stored two nearest anchor frames to the required frame provides the prediction for the current frame. Finally, the residual error part of the B-frame data when decoded and added to the prediction yields the final decoded frame. Thus, in one embodiment, in order to decode an arbitrary frame, the decoder object decodes no more than a single frame (e.g., using previously decoded anchor frames) regardless of whether the B-frame data has been previously communicated to receiving device 19, or not. This processing is sufficient for real-time immersive viewing.

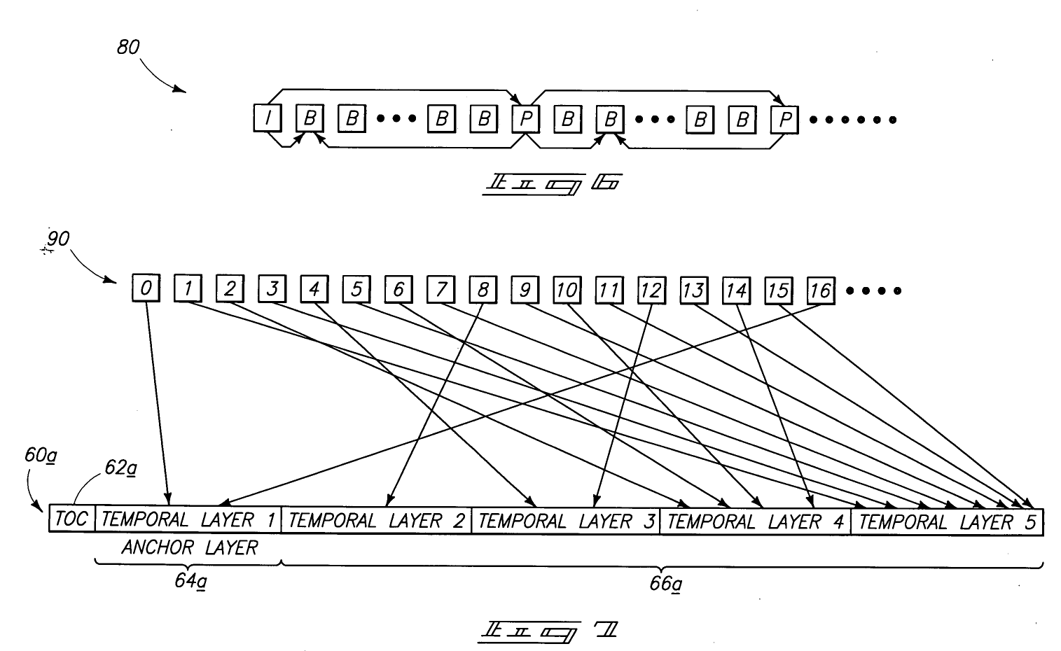

Referring to FIG. 5, a prediction structure 70 of an image sequence having anchor frames comprising only I-frames and the remaining frames comprising B-frames is shown with no P-frames. If not INTRA coded, the prediction mode for macroblocks of B-frames is one of forward prediction (i.e., predicted from a shifted forward reference macroblock), backward prediction (i.e., predicted from a shifted backward reference macroblock), or bi-directional prediction (e.g., predicted from an average of a shifted forward reference macroblock and a shifted backward reference macroblock).

Referring to FIG. 6, a prediction structure 80 of an image sequence having the first anchor frame comprise an I-frame, and the remaining frames comprising P-frames provides an embodiment of increased efficiency compared with the embodiment of FIG. 5. If not INTRA coded, the prediction mode for each macroblock of a B-frame is one of forward prediction (i.e., predicted from a shifted forward reference macroblock), backward prediction (i.e., predicted from a shifted backward reference macroblock), bi-directional prediction (i.e., predicted from an average of a shifted forward reference macroblock and a shifted backward reference macroblock), or direct prediction (i.e., predicted from a scaled down forward motion vector between the preceding anchor frame and the following anchor frame, with the scale factor being in the ratio of the temporal position of the B-frame between the two anchor frames). To accommodate direct prediction, the operation of the decoder object may become more complex. For example, when the decoder initializes with anchor frame data, it not only decodes a frame sequence I P P P etc. in order, but also remembers the motion vectors used to predict the successive P-frames in one embodiment. This is because these motion vectors would be referenced later when decoding the B-frames with direct prediction mode for the respective macroblocks.

As mentioned previously, the transmitting device 18 may implement scaling operations in at least some embodiments. For example, in heterogeneous implementations of communications system 10, transmitting device 18 embodied as organizer 12 may scale the media data differently for respective receiving devices 19 embodied as the participants 14. Additional details regarding scaling in a heterogeneous environment are described in U.S. patent application entitled “Communications Methods, Communications Session Organizers, Communications Session Participants, Articles Of Manufacture, And Communications Systems,” listing Debargha Mukherjee as inventor, having Attorney Docket No. 10017341-1, and U.S. patent application entitled “Communications Methods, Collaboration Session Communications Organizers, Collaboration Sessions, And Articles Of Manufacture,” listing Debargha Mukherjee and Amir Said as inventors, having Attorney Docket No. 10017342-1, both filed concurrently herewith and the teachings of which are incorporated herein by reference.

A scalable bit-stream may be organized into multiple nested layers, where different kinds of scalability such as temporal, spatial, and SNR, can be combined. In temporal scalability, a truncated version of the whole bit-stream produces a lower temporal resolution version of the media. Temporal scalability may be readily incorporated within the exemplary framework described herein inasmuch as anchor frames come every N (typically 16 or so) frames or so and the mere utilization of the anchor frame data automatically provides a low temporal resolution version of the sequence. That is, even if the B-frame data is deleted in entirety from the bit-stream, a low temporal resolution image sequence is provided. Furthermore, the B-frame data can be interleaved in order to produce more successively increasing temporal layers. For example, if N=16, a first temporal layer comprised only of anchor frames contains media data of every 16th frame (i.e., frame numbers 0, 16, 32, etc.). A second temporal layer in this example may contain B-frame numbers 8, 24, 40, etc. The third layer, also all B-frames, may contain frames 4, 12, 20, 28, 36, etc. The fourth layer may contain B-frames frames 2, 6, 10, 14, 18, 22, 26, 30, 34, etc. and finally, the fifth layer would consist of B-frames 1, 3, 5, 7, 9, 11, 13, 15, 17, 19, 21, 23, 25, 27, 29, 31, 33, 35, 37, 39, etc.

Referring to FIG. 7, successive layers for N=16 is illustrated according to one arrangement. A given image sequence 90 may be correlated to bit stream 60a comprising anchor frames data 64a and B-frames data 66a. B-frame data 66a may be readily reorganized in successively increasing temporal resolution layers, and the TOC 62a may be changed accordingly to support temporal scalability. Portions of B-frames data 66a may be truncated in one embodiment to implement scaling operations.

Referring to FIG. 8, exemplary spatial scalability concepts of media data are described. For spatial scalability, a truncated version of the whole bit-stream produces lower spatial resolution visualization. According to one embodiment, spatial scalability is incorporated in a second nested level within the temporal scalability layers. More specifically, each temporal scalability layer is further divided into multiple layers of increasing spatial scalability in the described embodiment. Furthermore, for the exemplary spatial scalability discussion, the anchor frames comprise I-frames in one embodiment.

Inasmuch as wavelet decomposition may be considered to lead naturally to spatial scalability, wavelet encoding of frames may be used in lieu of DCT based coding. More specifically, consider a color image sequence where individual images are decomposed into three components: Y, Cb, Cr (Typically, Cb and Cr are at half the resolution of Y). To encode the exemplary described frame, first wavelet decomposition with bi-orthogonal filters may be performed. For example, if a two-level decomposition is performed, the sub-bands may appear as shown in FIG. 8.

In one embodiment, the decomposition of FIG. 8 may be applied to both anchor I-frames as well as to B-frames on the motion compensation residual error. In both cases, wavelet decomposition is followed by quantization in the described embodiment. The quantized coefficients may then be scanned and encoded in subband-by-subband order from lowest to highest. In the described embodiment, subband 0 of Y, followed by subband 0 of Cb, followed by subband 0 of Cr produces the lowest spatial resolution layer. The next spatial resolution layer comprises information regarding subbands 1, 2 and 3 from all three components Y, Cb and Cr. The still next higher spatial resolution layer may comprise information regarding subbands 4, 5, and 6 from all three components Y, Cb and Cr. The higher spatial layers may repeat the described pattern. An arbitrary number of decomposition levels may be used, but note that the number of layers obtained is one more than the number of decompositions for spatial resolutions increasing by an octave per layer in one embodiment.

According to one scanning and encoding embodiment, coefficients in individual subbands are scanned in raster scan order, and the coefficients may be classified to a ternary symbol in {0, +, −}, meaning {Zero, Positive nonzero, Negative nonzero} respectively. The ternary classification symbol may be arithmetic encoded using a context triple {1, t, p}, where I and t are ternary symbols for the already encoded coefficients to the left and top of the current coefficient, and p is the ternary symbol for the parent of the current coefficient. There are a total of 3×3×3=27 different contexts provided by the described embodiment. For coefficients that are +ve or −ve, the respective magnitudes may be encoded by categorizing the coefficients into magnitude categories that are variable length encoded. The actual coefficient value within the category may then be binary encoded. An essence of the above encoding scheme is that at no point is any information about subbands sent or used that has not yet been covered in the scan in one implementation. The exemplary described method is unlike traditional zerotree encoding of wavelet coefficients, but allows a more efficient separation of the bit-stream into layers of successively increasing resolution in at least one embodiment.

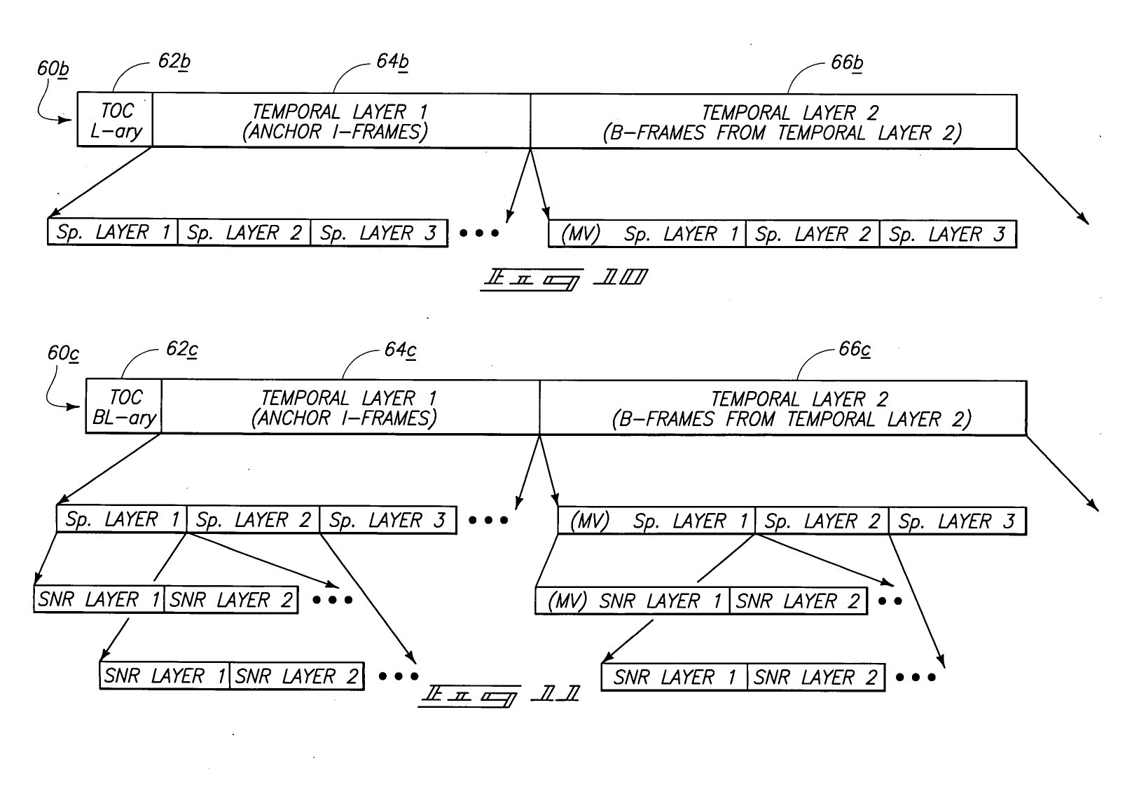

Referring to FIG. 9, exemplary bit-streams for I- and B-frames for 2-level wavelet decomposition having 3 spatial layers is shown according to one embodiment. Individual layers may be truncated to implement spatial scalability. In the illustrated arrangement, the B-frames have an additional component for motion vectors (MV), which may be included in the first spatial layer. The motion vectors may be sent at the highest resolution irrespective of the decoding scale of the respective decoder.

An advantage of the described scalable representation is that different decoders can use different truncated bit-streams from the parent full bit-stream to decode images at lower than full spatial resolutions. Random access is provided by an appropriate TOC in the file format enabling the decoder to randomly jump to different sections in the bit-stream in order to decode a requested image.

The operation of a full resolution decoder is facilitated because the entire bit-stream is available in at least one embodiment. For a lower resolution decoder (e.g., which retrieves images at lower than full resolution of the original), the decoder is able to decode images from a truncated bit-stream where the last one or more spatial layers have been removed from the frames. That is, for anchor frames as well as B-frames, coded information for only subbands 0 through 3x are available with x<L-1 (L corresponding to the number of spatial layers). The decoder may first decode I-frames from the anchor layer by decoding the quantized coefficients in subbands 0 through 3x (i.e. spatial layers 1 through (x+1)), performing inverse quantization, and then performing an inverse wavelet transform (up to x levels). The exemplary processing produces lower resolution anchor images which may be internally stored of the receiving device 19 or otherwise accessible using the decoder.

Thereafter, as a new frame is requested, the decoder may either produce the requested frame from the already decoded low resolution anchor frames, or decode a new B-frame at low resolution on the fly. In order to decode a low resolution B-frame, the decoder may perform sub-pixel motion compensation using low-resolution anchors but full resolution motion vectors in one embodiment. The predicted frame obtained by this process is at low resolution. The decoder next decodes the low resolution residual error data by coefficient decoding followed by inverse quantization followed by inverse wavelet transform, and adds the residual error component to the prediction error according to the described embodiment.

The above process provides advantages when used with processing of B-frames because there is no propagation of errors from them. There may be a trifle mismatch between a low-resolution image obtained by the above process, and a low-resolution image obtained by decimating a high-resolution image decoded from the full bit-stream. However, whatever minimal error is incurred does-not propagate to other frames because no other frames use B-frames for reference in the described embodiment. Furthermore, error build-up starting from an I-frame is limited to only first order prediction of B-frames and therefore the effect of this error is minimal in the embodiment of the prediction structure of FIG. 5 consisting entirely of I-anchor frames in the described arrangement.

FIG. 10 depicts an exemplary composite temporal and spatial bit stream 62b having nested temporal and spatial scalability layers. In the depicted arrangement, for both the anchor (I) frames and the B-frames, the spatial scalability layers for the frames are combined to form composite spatial scalability layers for the entire sequence. Nesting the spatial layers within the existing temporal layers eventually result in the nested bit stream 62b of FIG. 10. In the exemplary bit stream 62b, TOC 62b may simultaneously index to all the component spatial scalability layers. That is, for each requested frame, TOC 62b provides L offset values, one for each of the L spatial scalability layers.

The discussion now proceeds with respect to exemplary SNR scalability wherein a truncated version (e.g., truncated SNR layers) of the whole bit-stream produces lower quality (SNR) visualization. SNR scalability can be implemented as further nested layers within spatial scalability layers by modifying a coefficient encoding method into a bit-plane-by-bit-plane method in one embodiment. In one exemplary method, coefficients are encoded in several passes, where in each pass, one bit-plane for all coefficients in subbands belonging to a given spatial layer is encoded starting from the most significant and going towards the least. For example, the scans may be started at subband 0 of spatial layer 1 and the coefficients in subband 0 may be scanned in multiple passes with individual passes producing a different SNR layer bit-stream. Spatial layer 1 is complete when the least significant bit has been encoded. Processing may next be performed for spatial layer 2 where coefficients in subbands 1, 2, and 3 of three components (Y, Cb, and Cr) are scanned bit-plane-by-bit-plane to obtain multiple SNR layers within spatial layer 2. The exemplary methodology may be repeated for remaining spatial layers.

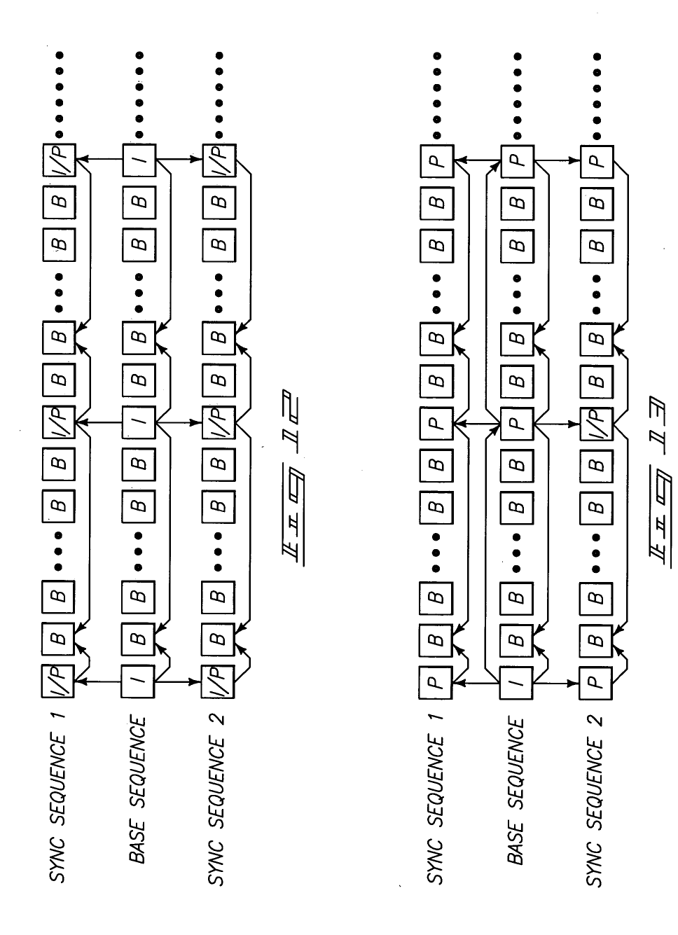

Referring to FIG. 11, nested temporal, spatial and SNR scalability layers combined in an exemplary bit stream 62c is shown. Combining bit-plane layers for individual frames together into aggregate SNR layers, and nesting them within the spatial layers provides bit stream 62c in one example. In the example of FIG. 11, the number of SNR layers is B and TOC 62c is BL-ary to provide pointers to all SNR layers in all spatial layers enabling the decoder to decode an arbitrary frame with random access capability in one embodiment.

In the exemplary nested scalable bit-streams described herein, overheads are provided within the first layers. Thus, SNR layer 1 in spatial layer 1 for B-frames contain motion vector information as well as the first bit-plane for the first spatial layer (containing subband 0) in one embodiment.

The use of B-frames in a SNR scalable structure also provides advantages when employed with the prediction structure of FIG. 5. For example, there is no propagation of errors from a B-frame, and the error propagation from an I-frame is limited to first order prediction in B-frames. Consequently, even if SNR layers are dropped in the interest of bandwidth or other considerations, the errors do not propagate more than one frame and hence do not build up significantly.

Referring to FIGS. 12-14, exemplary embodiments are described with respect to encoding and decoding multiple synchronous image sequences. The above-described aspects of one dimensional image sequences may be readily adapted to compress and view multiple synchronous image sequences. A multiple synchronous image sequence essentially contains several one-dimensional image sequences with the same number of images in each and which may be synchronized in time. In one embodiment, the corresponding frames in all sequences are associated in some sense. For example, they may represent the same object from the same view, but the object itself has undergone a discrete transformation from one sequence to the next (e.g., in one sequence a door of a house is closed and in the other sequence the door of the house is open). Possible applications are in interactive viewing of different manifestations of an object or scene.

Issues are raised with respect to compression inasmuch as the encoding includes encoding an essentially two-dimensional image sequence, but the second dimension is different from the first in that it does not represent a smooth progression of views but rather captures certain discrete interactions to the captured scene or object.

Referring to FIG. 12, one possible prediction structure that can be used to resolve the above issues is illustrated wherein three synchronous sequences are shown. The prediction structure for one of the three sequences, referred to as the illustrated base sequence, corresponds exactly to the prediction structure of FIG. 5 and includes I-frame anchors. The other two synchronous sequences (e.g., referred to as sync sequence 1 and sync sequence 2) use either all I anchor frames (as in the base sequence) or all P anchor frames. If P anchor frames are used for the synchronous sequences, they may be predicted from corresponding I-frames in the base sequence. Because respective image numbers across the sequences can be very similar, this type of prediction increases the compression efficiency substantially.

The above described forms of scalability readily apply to the above prediction structure. Note that even if P-frames are used in the base sequence of FIG. 12, error propagation is limited to two frames because the maximum prediction order for any frame is two.

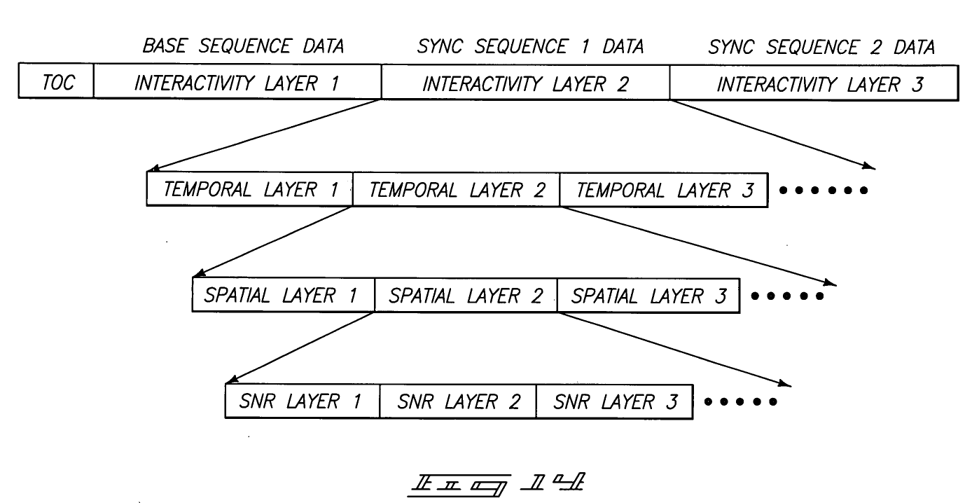

Referring to FIG. 13, an alternative prediction structure using IPPP anchors in the base sequence providing increased efficiency in terms of compaction is shown according to one embodiment. The base sequence prediction structure is exactly the same as FIG. 6. However, because of progressive P-frames in the base sequence, use of spatial and SNR scalability may lead to unsatisfactory viewing.

As for single sequences, the decoder of the receiving device 19 may initialize by decoding the anchor frames in all sequences and store the decoded frames. Thereafter, as a frame from one of the sequences is requested, the respective TOC is traversed to seek the appropriate bytes offsets, and a single B-frame is decoded at most to provide the requested media data.

Often, the multiple synchronous sequences represent different discrete interactions performed on an object which may be viewed interactively. On the other hand, the available bandwidth may not be sufficient to support the delivery of all the synchronous sequences. In such a situation, it may be beneficial to drop one or more of the synchronous sequences to provide the user with limited but basic amount of interactivity. This provides a new paradigm for bit-stream scalability, referred to as interactivity scalability. In interactivity scalability, the bit-stream is arranged so that truncated versions of the whole produce interactive media at lower levels of interactivity than the full.

More specifically, bit-streams for multiple synchronous sequences may be readily arranged to support interactivity scalability. Interactivity scalability forms the highest level of scalability, and may contain progressively nested temporal, spatial and SNR layers. The data for the base sequence forms the first layer, while data for subsequent sequences forms subsequent interactivity layers which may be truncated for scalability.

If four types of scalability are combined in a prediction structure as in FIG. 12, the eventual bit-stream for a four level nested scalability structure for multiple sequences is shown in FIG. 14. The TOC may be two-dimensional taking both the sequence number as well as the image number as the input, and providing a BL-ary offset output for the Spatial and SNR resolution layers which may be truncated for scalability.

Aspects of the disclosure allow efficient image sequence compression for purposes different than traditional linear time video. Exemplary described compression methods and the associated indexed file-formats allow the decoder to randomly access any frame in the sequence with minimal initialization overheads. Exemplary described embodiments may be used in interactive image based 3D or other viewing, where a user decides which frame in the sequence to decode next using a mouse, a joystick or other user input.

In addition, exemplary methods allow different types of scalability to co-exist in the same framework. That is, from the same compressed bit-stream, layers can be extracted that allow viewing at lower resolution, lower quality, etc. There is no need to create different versions of the media for different bandwidths, display resolutions, etc. Accordingly, at least some aspects of the disclosure include encoding or decoding algorithms, and file-formats to allow random access. Further, viewer architecture is provided to enable efficient scalable compression while preserving random access capability. It is believed that the proposed method can provide increased compression by a factor of 3-4 with respect to independent coding of images of a sequence for rich resolution media.

The protection sought is not to be limited to the disclosed embodiments, which are given by way of example only, but instead is to be limited only by the scope of the appended claims.

1. A data communications method comprising:
providing configuration parameters regarding capabilities associated with a receiving device and usable to implement scaling of media data to be recieved;
receiving media data scaled according to the configuration parameters and comprising a plurality of frames for generating a plurality of respective images;
initially decoding compressed media data for an initial one of the frames and less than all of the frames;
initially displaying at least one visual image using the initially decoded media data;
randomly selecting an other of the frames after the displaying;
subsequently decoding compressed media data of the other of the frames after the initially decoding and the initially displaying; and
subsequently displaying an other visual image using the subsequently decoded media data.

2. The method of claim 1 wherein the initially decoding comprises decoding frames of a first type and the subsequently decoding comprises decoding frames of a second type different than the first type, and wherein the first type of frames comprise data usable to decode the second type of frames.

3. The method of claim 1 wherein the media data comprises data for a plurality of multiple sequences of visual images synchronized with one another.

4. The method of claim 1 further comprising accessing a user input entered responsive to user navigation of the at least one visual image, and wherein the randomly selecting comprises selecting the other of the frames responsive to the user input.

5. The method of claim 1 wherein the compressed media data comprises data for a sequence of a plurality of images, and the randomly selecting comprises selecting the other of the frames out of sequence.

6. The method of claim 1 wherein the subsequently decoding comprises decoding compressed media data of no more than one frame to display the other visual image.

7. The method of claim 1 further comprising:
accessing the configuration parameters within a sending device; and
scaling the compressed media data according to the configuration parameters to provide data steams of the compressed media data comprising different amounts of data for a given subject.

8. The method of claim 7 wherein the scaling comprises scaling according to at least one of temporal, spatial, signal-to-noise ratio, and interactivity scaling attributes.

9. The method of claim 1 wherein the frames individually comprise temporal, spatial, signal-to-noise ratio, and interactivity levels of scalability.

10. A compressed media data decoding method comprising:
accessing compressed media data of a plurality of frames corresponding to a sequence of images, wherein the frames correspond to a plurality of respective images of the sequence;
accessing a plurality of data requests for selected ones of the images;
selecting respective ones of the frames of the media data responsive to the data requests; and
decoding compressed image data of the selected ones of the frames, wherein the decoding comprises decoding at least some of the frames out of sequence responsive to the selecting.

11. The method of claim 10 further comprising receiving the frames in a linear order corresponding to the sequence of the images.

12. The method of claim 10 wherein the accessing the compressed media data comprises receiving the compressed media data within a recipient communications device, and further comprising providing configuration parameters corresponding to capabilities of the recipient communications device, and the receiving comprises receiving the compressed media data scaled according to the configuration parameters.

13. The method of claim 10 further comprising:
decoding compressed media data of a plurality of a first type of frames, and wherein the data requests correspond to images generated using media data of the first type of frames, and wherein the decoding the selected ones of the frames comprises decoding a second type of frames different than the first type of frames.

14. The method of claim 13 wherein the data requests correspond to user inputs of a user navigating the images generated using the media data of the first type of frames.

15. A compressed media data decoder comprising:
an interface configured to access compressed media data comprising a plurality of frames usable to generate a plurality of respective images, wherein the frames comprise a plurality of frame types; and
processing circuitry coupled with the interface and configured to initially decode a first type of the frames at an initial moment in time to initiate viewing of at least one of the images, to control a display to depict the at least one image, to access a data request for depiction of another one of the images after the depiction of the at least one image, and to decode the compressed media data of another frame comprising a second type of frame using the initially decoded media data of the frame corresponding to the at least one image.

16. The decoder of claim 15 wherein the data requests are generated responsive to user interaction with the at least one image, and the processing circuitry is configured to initially decode the first type of frames without user input.

17. The decoder of claim 15 wherein the compressed media data comprises data for a sequence of a plurality of images comprising a linear order, and the processing circuitry is configured to decode the compressed media data of the another frame out of sequence and responsive to user input.

18. The decoder of claim 15 wherein the processing circuitry is configured to decode an entirety of the compressed media data of the first type of frames prior to decoding the compressed media data of the second type of frames.

19. The decoder of claim 18 wherein the first type of frames comprise anchor frames.

20. The decoder of claim 15 wherein the processing circuitry is configured to control the display of at least one image prior to decoding of all of the accessed compressed media data.

21. The decoder of claim 15 wherein the processing circuitry is further configured to provide configuration parameters corresponding to capabilities of a recipient communications device associated with the compressed media data decoder, and wherein the compressed media data comprises data scaled according to the configuration parameters.

22. The decoder of claim 21 wherein the processing circuitry is configured to decode the scaled data.

23. The decoder of claim 15 wherein the processing circuitry is configured to decode no more than a single one of the second type of frames to depict the another one of the images.

24. An article of manufacture comprising:
processor-usable media comprising programming configured to cause processing circuitry to:
access compressed media data of a plurality of frames for a plurality of images of a sequence;
access a plurality of data requests with respect to the compressed media data;
select at least some of the frames for decoding responsive to the data requests;
decode the compressed media data of the selected frames, wherein the selecting and decoding comprise selecting and decoding the compressed media data of the frames out of sequence;
implement generation of respective images using the decoded media data.

25. The article of claim 24 wherein the compressed media data comprises data of the frames arranged in a linear order corresponding to the sequence of the images.

26. The article of claim 24 wherein the decoding comprises decoding the compressed media data of the selected ones of the frames in real time during user navigation of at least one of the images.

27. The article of claim 24 wherein the programming is configured to cause processing circuitry to initiate decoding of at least some of the compressed media data without user input, and the data requests are generated responsive to user navigation of an image generated using media data decoded without the user input.

28. A data communications system comprising:
transmitting means for accessing media data of a plurality of frames for a sequence of visual images of at least one subject, for encoding the media data using a compression scheme providing compressed media data comprising a plurality of different frame types, and for outputting the compressed media data after the encoding; and
receiving means coupled with the transmitting means and comprising means for receiving the compressed media data after the outputting, wherein the receiving means further comprises means for initiating decoding of the compressed media data of a first type of the frames less than all the frames to initiate viewing of one of the images of the subject, for accessing a plurality of data requests for images comprising compressed media data of a second type of the frames, and for decoding the compressed media data of respective requested ones of the second type of the frames responsive to the data requests.

29. The system of claim 28 wherein the transmitting means comprises means for transmitting the first type of frames at an initial moment in time and for transmitting the second type of frames at a subsequent moment in time responsive to the data requests from the receiving means.

30. The system of claim 28 further comprising providing configuration parameters corresponding to capabilities of the receiving means, and the receiving comprises receiving the compressed media data scaled according to the configuration parameters.

31. The system of claim 28 wherein the receiving means comprises means for communicating respective configuration parameters to the transmitting means, and the transmitting means comprises means for scaling the compressed media data according to the configuration parameters.

32. The system of claim 28 wherein the receiving means comprises means for initiating the decoding without requests for the media data of the first type of frames.

33. The system of claim 28 wherein the receiving means comprises means for depicting at least one visual image using media data of the initially decoded first type of frames prior to decoding of an entirety of the compressed media data.

34. The system of claim 28 wherein the receiving means comprises means for decoding the compressed media data of the second type of frames using initially decoded media data of the first type of frames.

35. The system of claim 28 wherein the receiving means comprises means for decoding the compressed media data of the second type of frames responsive to user interaction with decoded media data of the first type of frames.

36. The system of claim 28 wherein the receiving means comprises means for decoding all of the first type of frames comprising anchor frames before the receiving the data requests, and for depicting an image responsive to the decoding the second type of frames comprising B frames, and for decoding no more than a single one of the B frames to depict the image.

37. The system of claim 28 wherein the receiving means comprises means for decoding the second type of the frames out of sequence.
